(19) United States
(12) Patent Application Publication
(10) Pub. No.: US 2025/0075981 A1
(43) Pub. Date: Mar. 6, 2025

(54) Folded Double Wall Heat Exchanger Tubes and Methods of Manufacture

(71) Applicant: Rheem Manufacturing Company, Atlanta, GA (US)

(72) Inventors: Alex L. Williams, Montgomery, AL (US); Govinda Mahajan, Pike Road, AL (US); Atilhan Manay, Roswell, GA (US); Kevin Mercer, Danville, IN (US)

(21) Appl. No.: 18/812,152

(22) Filed: Aug. 22, 2024

Related U.S. Application Data
(60) Provisional application No. 63/579,129, filed on Aug. 28, 2023.

(51) Int. Cl. F28D 1/03

(52) U.S. Cl. CPC F28D 1/0391

(57) ABSTRACT

A method of manufacturing a heat exchanger tube is disclosed. The method may include folding a single sheet of material onto itself to form a folded sheet of material and forming first and second pluralities of ridges on a first portion of the folded sheet and a second portion of the folded sheet. The method may further include folding the first portion about a first portion distal end to overlay on a third portion of the folded sheet, and the second portion about a second portion proximal end to overlay on a fourth portion of the folded sheet. Furthermore, the method may include folding the third inner portion about a third portion distal end to overlay on a fifth portion of the folded sheet and folding the fourth portion about a fourth portion proximal end to overlay on the fifth portion to form the heat exchanger tube.

### CROSS-REFERENCE TO RELATED APPLICATIONS

The present applications claims priority to and the benefit of U.S. application No. 63/579,129, filed Aug. 28, 2023, which is hereby incorporated by reference herein in its entirety.

### FIELD

The present disclosure relates to heat exchanger tubes and more specifically to folded double wall heat exchanger tubes and methods of manufacture thereof that may be disposed inside water tanks of water heaters.

### BACKGROUND

Water heaters are generally used to provide a supply of heated water in a variety of applications, including residential, commercial, and industrial applications. Conventional water heaters use gas burners, electrical heating elements, heat pumps, and/or solar panels (or other renewable sources) to heat water. For example, a heat pump water heater may draw heat from ambient air to transfer heat to a refrigerant, which in turn may heat water stored in a tank of a water heater.

Some modern water heaters include microchannel tubes as heat exchanger to circulate the refrigerant inside the tank of the water heater to heat water therein. In some conventional tubes, the refrigerant may leak from the tubes, which is undesirable. Thus, there exists a need for a tube that may prevent leakage of the refrigerant into the tank of the water heater.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts a cross-sectional view of a water heating device in accordance with one or more embodiments of the present disclosure.

FIG. 2 depicts an isometric view of a water storage tank and a heat exchanger tube in accordance with one or more embodiments of the present disclosure.

FIG. 3 depicts a first process to manufacture a heat exchanger tube in accordance with one or more embodiments of the present disclosure.

FIG. 4 depicts a second process to manufacture a heat exchanger tube in accordance with one or more embodiments of the present disclosure.

FIG. 5 depicts a flow diagram of a method to manufacture a heat exchanger tube in accordance with one or more embodiments of the present disclosure.

### DETAILED DESCRIPTION

The present disclosure is directed to a water heater having a water tank configured to store water therein. In certain embodiments, the water heater may include a heat source (such as a heat pump or the like) that may be configured to heat water in the water tank. The heat source may be configured to provide heat to a heat transfer fluid (such as a refrigerant or the like), which may flow in a heat exchanger. In certain embodiments, the heat exchanger may be disposed inside the water tank and may be configured to transfer heat from the refrigerant to the water inside the water tank. In other embodiments, the heat exchanger may externally surround the water tank or itself form the water tank or at least a portion thereof (e.g., the heat exchanger may be a wall of the water tank).

In certain embodiments, the heat exchanger may include a heat exchanger tube that may be configured to circulate refrigerant inside the water tank and heat the water. The heat exchanger tube may be a double walled tube having an inner wall and an outer wall surrounding the inner wall. In some aspects, the inner wall and the outer wall may be formed by folding a single sheet of material onto itself and form a folded sheet of material. The inner wall and the outer wall may include a plurality of ridges/teeth disposed at opposite edges of the folded sheet (e.g., at a proximal end and a distal end of the folded sheet). A center/middle portion of the folded sheet may be straight or flat. In certain embodiments, the proximal end and the distal end may be disposed at the opposing ends of the folded sheet. In other embodiments, the proximal end and the distal end may not be disposed at the opposing ends but may be disposed at a non-zero distance from the opposing ends. In such scenarios, the plurality of ridges may also be disposed at the non-zero distance from the opposing ends.

In some aspects, the inner wall and the outer wall may be folded to form a top surface, a bottom surface and side walls of the heat exchanger tube. The inner wall and the outer wall may be folded such that the plurality of ridges is disposed between the top surface and the bottom surface and form flow channels or microchannels of the heat exchanger tube through which the refrigerant may flow.

In certain embodiments, the heat exchanger tube may be manufactured by using a folding process/method. In some instances, the heat exchanger tube may be formed by folding a single sheet of material (e.g., sheet metal or other sheet alloys or composite materials) multiple times to form a double walled heat exchanger tube having a plurality of microchannels. In this manner, the multiple folds in the single sheet may result in a plurality of microchannels, each of which are double walled to prevent or reduce leakage of the fluid within the microchannels into the water within the water heater. As used herein, the term “double walled” may mean a fluid channel (e.g., a microchannel) that includes a first inner wall surrounded by a second outer wall. Although described as “double walled,” the microchannels may include any number of walls. For example, the sheet of material may be folded any number of times in order to create one or more microchannels having N number of walls.

In some instances, the manufacturing process/method may include folding a single sheet of material onto itself to form a folded sheet. The method may further include forming the plurality of ridges via one or more folds on the proximal end and the distal end of the folded sheet. Specifically, the plurality of ridges may be formed on a first portion and a second portion of the folded sheet. The method may further include folding the first portion about a first portion distal end to completely overlay on a third portion of the folded sheet, and folding the second portion about a second portion proximal end to completely overlay on a fourth portion of the folded sheet. The third portion may be adjacent to the first portion, and the fourth portion may be adjacent to the second portion. A fifth portion of the folded sheet may exist between the third portion and the fourth portion. The plurality of ridges may not be formed on the third portion, the fourth portion, and the fifth portion.

The method may further include folding the third inner portion about a third portion distal end to completely overlay on the fifth inner portion, and folding the fourth inner portion about a fourth portion proximal end to completely overlay on the fifth inner portion to form the heat exchanger tube having the plurality of ridges as flow channels through which the heat transfer fluid (e.g., the refrigerant) may flow.

The present disclosure discloses a double-walled heat exchanger tube that prevents leakage of refrigerant in the water tank, for example, when the heat exchanger tube may be submerged in the water tank. Further, in certain embodiments, the present disclosure provides flexibility to a user to manufacture the heat exchanger tube with walls of different materials.

Although certain examples of the disclosed technology are explained in detail herein, it is to be understood that other examples, embodiments, and implementations of the disclosed technology are contemplated. Accordingly, it is not intended that the disclosed technology is limited in its scope to the details of construction and arrangement of components expressly set forth in the following description or illustrated in the drawings. The disclosed technology can be implemented in a variety of examples and can be practiced or carried out in various ways. In particular, the presently disclosed subject matter is described in the context of being a system and method for heating water with a heat pump and microchannel heat exchanger. The present disclosure, however, is not so limited, and can be applicable in other contexts. The present disclosure, for example and not limitation, can be applied to heating water with heating sources. Furthermore, the present disclosure can include other fluid heating systems configured to heat a fluid other than water such as process fluid heaters used in industrial applications. Such implementations and applications are contemplated within the scope of the present disclosure. Accordingly, when the present disclosure is described in the context of being a system and method for heating water with a heat pump and microchannel heat exchanger, it will be understood that other implementations can take the place of those referred to.

Although the term “water” is used throughout this specification, it is to be understood that other fluids may take the place of the term “water” as used herein. Therefore, although described as a system and method to heat water, it is to be understood that the system and method described herein can apply to fluids other than water. Further, it is also to be understood that the term “water” can replace the term “fluid” as used herein unless the context clearly dictates otherwise.

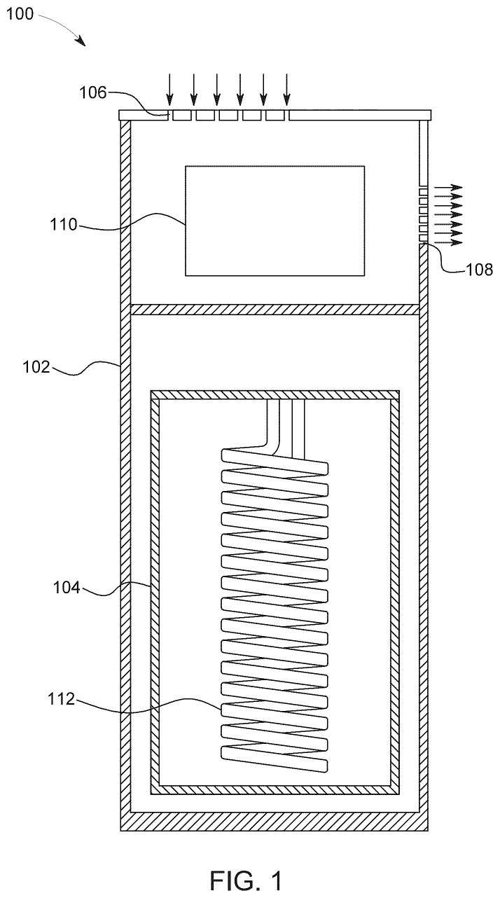

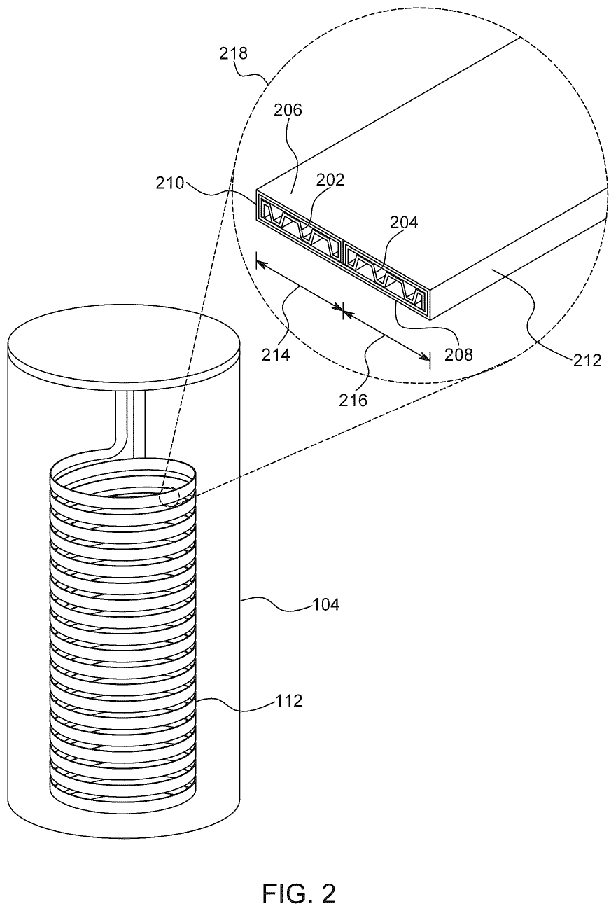

Turning now to the drawings, FIG. 1 depicts a cross-sectional view of a water heater or a water heating device 100 in accordance with one or more embodiments of the present disclosure. While describing FIG. 1, references will be made to FIG. 2. FIG. 2 depicts an isomeric view of a water storage tank and a heat exchanger tube of the water heating device 100, in accordance with one or more embodiments of the present disclosure.

The water heating device 100 may include a housing 102 defining an interior chamber of the water heating device 100. The housing 102 may include a water storage tank 104 (or a fluid tank) for storing water or any fluid to be heated.

The water storage tank 104 (and/or the housing 102) may be of any size, shape, or configuration based on the water heating device application. For example, the water storage tank 104 may be sized for common residential use or for commercial or industrial use that may require greater amounts of heated water. Furthermore, the water storage tank 104 may be made of any suitable material for storing and heating water, including copper, carbon steel, stainless steel, ceramics, polymers, composites, or any other suitable material. The water storage tank 104 may also be treated or lined with a coating to prevent corrosion and leakage. The water storage tank 104 may be treated or coated with any suitable coating that may be capable of withstanding temperature and pressure of the water heating device 100, and may include, as non-limiting examples, glass enameling, galvanizing, thermosetting resin-bonded lining materials, thermoplastic coating materials, cement coating, or any other suitable treating or coating for the application. Optionally, the water storage tank 104 may be insulated to retain heat. For example, the water storage tank 104 may be insulated using foam, fiberglass, aluminum foil, organic material, or any other suitable insulation material.

The housing 102 may further include an air inlet 106 and an air outlet 108. The air inlet 106 may be configured to receive ambient air from outside and pass the air to the interior portion of the housing 102, and the air outlet 108 may be configured to output exhaust air from the interior portion of the housing 102 to outside. The air inlet 106 may be disposed at the top wall of the housing 102 and the air outlet 108 may be disposed at a side wall of the housing 102, or vice versa. In other aspects, the air inlet 106 may be disposed at the side wall, opposite to the air outlet 108.

The water heating device 100 may further include a heating source 110 configured to heat water in the water storage tank 104. In an exemplary aspect, the heating source 110 may include a heat pump (or a heat pump assembly). In other aspects, the heating source 110 may include a solar heating unit or any other heating source. Any suitable heating source may be used herein. Hereinafter, the heating source 110 is considered to be a heat pump. The heat pump may include an evaporator, a compressor, a heat

exchanger/condenser (including a heat exchanger tube 112 that may be disposed inside the water storage tank 104) and an expansion valve connected in series by a refrigerant tubing through which, during heat pump operation, a refrigerant may flow. Specifically, the refrigerant may sequentially flow from a compressor outlet, through the heat exchanger tube 112, through the expansion valve, through the evaporator, and back to a compressor inlet. The refrigerant may be any suitable refrigerant, for example, R22 or R410A. The evaporator, the compressor, and the expansion valve of the water heating device 100 may be conventional evaporator, compressor and expansion valve, and hence their functions are not described here in detail.

In some aspects, the heat exchanger tube 112 may be submerged inside the water storage tank 104, as shown in FIG. 1. The heat exchanger tube 112 may be configured to receive the refrigerant from the compressor and transfer heat from the refrigerant to the water stored in the water storage tank 104. In some aspects, the heat exchanger tube 112 may be a helical heat exchanger tube. In other aspects, the heat exchanger tube 112 may be a conical heat exchanger tube or a ball heat exchanger tube. Any suitable heat exchanger tube configuration may be used herein.

Although FIG. 1 depicts an aspect where the heat exchanger tube 112 is submerged in the water storage tank 104, the present disclosure is not limited to such an arrangement. For example, in certain embodiments, the heat exchanger tube 112 may be externally wrapped around the wall of the water storage tank 104 and configured to heat water stored in the water storage tank 104.

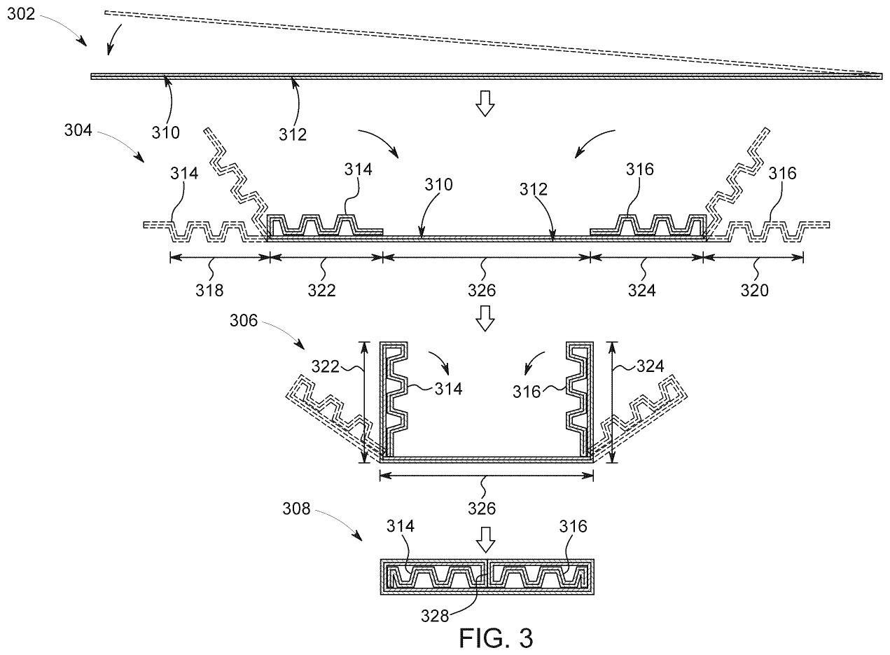

In some aspects, the heat exchanger tube 112 may be a double-walled tube that may prevent leakage of the refrigerant from the heat exchanger tube 112 to outside (e.g., in the water storage tank 104). Specifically, the heat exchanger tube 112 may include an inner wall (shown as inner wall 310 in FIG. 3) and an outer wall (shown as outer wall 312 in FIG. 3) that may be disposed at an exterior surface of the inner wall. Stated another way, the outer wall may surround the inner wall to prevent leakage of the refrigerant from the heat exchanger tube 112. In certain embodiments, the inner wall and the outer wall may be formed by folding a single sheet of material onto itself and form a folded sheet of material. In some aspects, a thickness of the inner wall may be same as a thickness of the outer wall. In an exemplary aspect, the thickness may be in a range of 0.1 to 5 mm. In addition, a length of the inner wall may be equivalent to a length of the outer wall. Stated another way, the single sheet of material may be folded at a center portion of the sheet, as described below in conjunction with FIG. 3.

In certain embodiments, the inner wall and the outer wall may include a first plurality of ridges 202 on a proximal end of the folded sheet, a second plurality of ridges 204 on a distal end of the folded sheet, and a straight portion (not shown in FIG. 2) between the first plurality of ridges 202 and the second plurality of ridges 204. In some aspects, the first plurality of ridges 202 and the second plurality of ridges 204 may have similar shape, for example, frustoconical cross-section or trapezoidal shape. In certain embodiments, a count of the first plurality of ridges 202 and a count of the second plurality of ridges 204 may be equivalent. In other embodiments, the count of first plurality of ridges 202 and the count of the second plurality of ridges 204 may be different.

The inner wall and the outer wall may be folded via opposing edges/ends of the folded sheet to form a top surface 206, a bottom surface 208 and side walls 210, 212 of the heat exchanger tube 112. In some aspects, folding of the inner wall and the outer wall may also fold the first plurality of ridges 202 and the second plurality of ridges 204. The process of folding the inner wall and the outer wall to form the heat exchanger tube 112 including the first and second plurality of ridges 202, 204 is described in detail later below in conjunction with FIG. 3.

The inner wall and the outer wall may be folded such that the first plurality of ridges 202 and the second plurality of ridges 204 may be disposed between the top surface 206 and the bottom surface 208, and form a first portion 214 and a second portion 216 of the heat exchanger tube 112. In some aspects, the first portion 214 may be identical to the second portion 216. In other aspects, the first portion 214 may be different from the second portion 216.

In some aspects, the first plurality of ridges 202 and the second plurality of ridges 204 form or act as flow channels of the heat exchanger tube 112. The flow channels may be microchannels or ports that provide passage for the refrigerant. Stated another way, the refrigerant received from the compressor may flow through the first and second plurality of ridges 202, 204, thus enabling circulation of the refrigerant through the heat exchanger tube 112.

In some aspects, the first plurality of ridges 202 and the second plurality of ridges 204 may be folded such that a proximal end of the first plurality of ridges 202 and a distal end of the second plurality of ridges 204 may be attached to each other. For example, the proximal end of the first plurality of ridges 202 and the distal end of the second plurality of ridges 204 may be sealed/welded. In an exemplary aspect, a total count of ridges (or flow channels) in the first and second plurality of ridges 202, 204 may be in a range of 16 to 32, which may enable the heat exchanger tube 112 to efficiently receive and circulate the refrigerant and transfer the heat to the water storage tank 104.

In certain embodiments, the top surface 206 and the bottom surface 208 may be flattened, as shown in view 218 of FIG. 2. Stated another way, a plane (e.g., an X-Y plane) of the top surface 206 may be parallel to a plane (e.g., an X-Y plane) of the bottom surface 208. The top and bottom surfaces 206, 208 may be attached to each other via the side walls 210, 212 such that a predetermined small distance may exist between the top and bottom surfaces 206, 208 to form a fluid conduit. The predetermined small distance may include the first and second plurality of ridges 202, 204 described above. As depicted in FIG. 2, the side walls 210, 212 may be disposed perpendicular to the top and bottom surfaces 206, 208.

In certain embodiments, the heat exchanger tube 112 may be a cuboidal tube of predetermined thickness/width. In some aspects, a width of the heat exchanger tube 112 may be in a range of 12 mm to 32 mm. In other instances, the width of the heat exchanger tube 112 may be between about 5 mm to 100 mm. In some embodiments, the gap between the top surface 206 and the bottom surface 208 may be in a range of 0.5 mm to 5 mm. In other instances, the gap between the top surface 206 and the bottom surface 208 may be in a range of 0.1 mm to 50 mm. In further aspects, each ridge of the first and second plurality of ridges 202, 204 may have a cross-sectional area in a range of 0.1 mm*0.1 mm to 50 mm*50 mm. The above-mentioned dimensions are exemplary and not limiting.

FIG. 3 depicts example snapshots illustrating a first process to manufacture a heat exchanger tube (e.g., the heat exchanger tube 112) in accordance with one or more embodiments of the present disclosure. Specifically, FIG. 3 depicts four stages (e.g., a first stage 302, a second stage 304, and a third stage 306, and a fourth stage 308) of manufacturing the heat exchanger tube 112 using a folding method/process.

At stage 302, a single sheet of material (e.g., an aluminum sheet or any other material such as carbon steel, stainless steel, nickel alloys, ceramic, polymer, and titanium) may be folded onto itself (e.g., into half) to form a folded sheet of material, thereby forming an inner wall 310 and an outer wall 312. In some aspects, folding onto itself means axially rotating the single sheet about a middle portion of the single sheet.

At the stage 304, a first plurality of ridges 314 may be formed on a proximal end of the folded sheet (e.g., on both the inner wall 310 and the outer wall 312), and a second plurality of ridges 316 may be formed on a distal end of the folded sheet (e.g., on both the inner wall 310 and the outer wall 312). In some aspects, the ridges may be formed by using roll-forming process or any other known manufacturing process. The first plurality of ridges 314 and the second plurality of ridges 316 may be formed on opposite ends of the folded aluminum sheet (e.g., distal and proximal ends of the folded sheet). The first plurality of ridges 314 may be same as the first plurality of ridges 202 and the second plurality of ridges 316 may be same as the second plurality of ridges 204 described above in conjunction with FIG. 2. In some aspects, the first plurality of ridges 314 may be formed on a first portion 318 of the folded sheet, and the second plurality of ridges 316 may be formed on a second portion 320 of the folded sheet. A length of the first portion 318 may be equivalent to a length of the second portion 320. Further, a count of the first plurality of ridges 314 may be equivalent to a count of the second plurality of ridges 316.

Furthermore, at the stage 304, the first portion 318 may be folded about a distal end of the first portion 318 (e.g., at which the first plurality of ridges 314 may end) such that the first portion 318 overlays (e.g., completely) on a third portion 322 of the folded sheet. In some aspects, folding the first portion 318 about the distal end means axially rotating the first portion 318 about the distal end. Similarly, the second portion 320 may be folded about a proximal end of the second portion 320 (e.g., at which the second plurality of ridges 316 may end) such that the second portion 320 overlays (e.g., completely) on a fourth portion 324 of the folded sheet. As depicted in FIG. 3, the third portion 322 may be adjacent to the first portion 318, and the fourth portion 324 may be adjacent to second portion 320.

In some aspects, a length of the third portion 322 may be equivalent to the length of the first portion 318. Further, a length of the fourth portion 324 may be equivalent to the length of the second portion 320. In some aspects, a center portion (e.g., a fifth portion 326) of the folded sheet may exist between the third portion 322 and the fourth portion 324. The third portion 322, the fourth portion 324, and the fifth portion 326 may not include ridges, as shown in FIG. 3. In some aspects, a length of the fifth portion 326 may be equivalent to a sum of the lengths of the third portion 322 and the fourth portion 324.

At the stage 306, the third portion 322 and the fourth portion 324 may be folded towards each other. Specifically, the third portion 322 may be folded (or axially rotated) about a distal end of the third portion 322, and the fourth portion 324 may be folded (or axially rotated) about a proximal end of the fourth portion 324. In the exemplary aspect depicted in FIG. 3, at the stage 306, the third portion 322 and the fourth portion 324 may be folded to be perpendicular to the fifth portion 326. Stated another way, the third portion 322 and the fourth portion 324 may be made to be parallel to each other and perpendicular to the fifth portion 326 at the stage 306.

At the stage 308, the third portion 322 and the fourth portion 324 may be folded to overlay on the fifth portion 326. Specifically, the third portion 322 may be folded (or axially rotated) about the distal end of the third portion 322 to overlay (e.g., completely) on the fifth portion 326, and the fourth portion 324 may be folded (or axially rotated) about the proximal end of the fourth portion 324 to overlay (e.g., completely) on the fifth portion 326 to form the heat exchanger tube 112. In the heat exchanger tube 112 formed by the process described above, the first plurality of ridges 314 and the second plurality of ridges 316 form or act as flow channels of the heat exchanger tube 112 through which the refrigerant flows.

At the completion of the stage 308, the first plurality of ridges 314 and the second plurality of ridges 316 may contact the fifth portion 326, as shown in FIG. 3. In certain embodiments, the first plurality of ridges 314 and the second plurality of ridges 316 may be attached (e.g., welded) to each other at an intersection point 328, such that a proximal end of the first plurality of ridges 314 and a distal end of the second plurality of ridges 316 may be attached to each other.

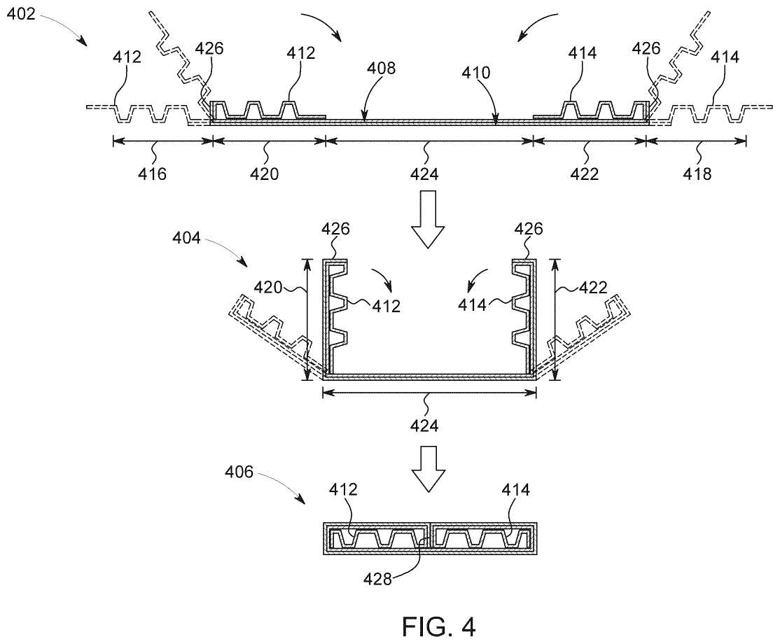

FIG. 4 depicts example snapshots illustrating a second process to manufacture a heat exchanger tube (e.g., the heat exchanger tube 112) in accordance with one or more embodiments of the present disclosure. Although the description above describes an aspect where the heat exchanger tube 112 is formed by using a single sheet of material, the present disclosure is not limited to the use of a single sheet of material to form the heat exchanger tube 112. In some aspects, two separate sheets of materials (same or different) may be used to form the heat exchanger tube 112, as described below in conjunction with FIG. 4.

Specifically, FIG. 4 depicts three stages (e.g., a first stage 402, a second stage 404, and a third stage 406) of manufacturing the heat exchanger tube 112 using a folding method/process. As described above, the heat exchanger tube 112 may include an inner wall 408 and an outer wall 410. The inner wall 408 may be made of a first aluminum sheet (e.g., a first single sheet) or of any other metal sheet, and the outer wall 410 may be made of a second aluminum sheet (e.g., a second single sheet) or of any other metal sheet. The process of manufacturing the heat exchanger tube 112 is described below.

At the stage 402, a first plurality of ridges 412 may be formed on a proximal end of the inner wall 408, and a second plurality of ridges 414 may be formed on a distal end of the inner wall 408 (i.e., on opposite ends of the first aluminum sheet). The first plurality of ridges 412 may be same as the first plurality of ridges 202, 314 and the second plurality of ridges 414 may be same as the second plurality of ridges 204, 316. In some aspects, the first plurality of ridges 412 may be formed on a first inner portion 416 of the inner wall 408, and the second plurality of ridges 414 may be formed on a second inner portion 418 of the inner wall 408. A length of the first inner portion 416 may be equivalent to a length of the second inner portion 418. Further, a count of the first plurality of ridges 412 may be equivalent to a count of the second plurality of ridges 414.

Furthermore, at the stage 402, the first inner portion 416 may be folded about a distal end of the first inner portion 416 (e.g., at which the first plurality of ridges 412 may end) such that the first inner portion 416 overlays (e.g., completely) on a third inner portion 420 of the inner wall 408. Similarly, the second inner portion 418 may be folded about a proximal end of the second inner portion 418 (e.g., at which the second plurality of ridges 414 may end) such that the second inner portion 418 overlays (e.g., completely) on a fourth inner portion 422 of the inner wall 408. As depicted in FIG. 4, the third inner portion 420 may be adjacent to the first inner portion 416, and the fourth inner portion 422 may be adjacent to second inner portion 418.

In some aspects, a length of the third inner portion 420 may be equivalent to the length of the first inner portion 416. Further, a length of the fourth inner portion 422 may be equivalent to the length of the second inner portion 418. In some aspects, a center portion (e.g., a fifth inner portion 424) of the inner wall 408 may exist between the third inner portion 420 and the fourth inner portion 422. The third inner portion 420, the fourth inner portion 422, and the fifth inner portion 424 may not include ridges, as shown in FIG. 4. In some aspects, a length of the fifth inner portion 424 may be equivalent to a sum of the lengths of the third inner portion 420 and the fourth inner portion 422.

In addition, at stage 302, the outer wall 410 may be attached to the inner wall 408. In some aspects, the outer wall 410 may be attached to an exterior surface of the inner wall 408 opposite to the first plurality of ridges 412 and the second plurality of ridges 414. In certain embodiments, the outer wall 410 may be attached to the third inner portion 420, the fourth inner portion 422 and the fifth inner portion 424. In further aspects, the outer wall 410 may be additionally attached to a part of each of the first inner portion 416 and the second inner portion 418. For example, as shown in FIG. 4, the outer wall 410 may be attached to a portion 426 of each of the first plurality of ridges 412 and the second plurality of ridges 414. In some aspects, the portion 426 may be a portion/wall of a ridge (associated with the first plurality of ridges 412 and the second plurality of ridges 414) that may be adjacent to the third inner portion 420 and the fourth inner portion 422, and may have a length equivalent to a height of each ridge (which may be, for example, in a range of 0.5 mm to 5 mm).

The outer wall 410 may include a first outer portion, a second outer portion and a third outer portion. The second outer portion may be disposed between the first outer portion and the third outer portion. In certain embodiments, the process step of attaching the outer wall 410 to the inner wall 408 may include attaching the first outer portion to the third inner portion 420, attaching the third outer portion on the fourth inner portion 422, and attaching the second outer portion on the fifth inner portion 424. Dimensions of the first outer portion, the second outer portion and the third outer portion may be equivalent to dimensions of the third inner portion 420, the fifth inner portion 424 and the fourth inner portion 422, respectively. In certain embodiments, a part of the first outer portion and the third outer portion may be folded to cover the portion 426 of the first plurality of ridges 412 and the second plurality of ridges 414. In this case, the length of the first outer portion may be equivalent to a sum of the lengths of the third inner portion 420 and the portion 426. Similarly, the length of the third outer portion may be equivalent to a sum of the lengths of the fourth inner portion 422 and the portion 426. Further, the length of the second outer portion may be equivalent to the length of the fifth inner portion 424.

At the stage 404, the third inner portion 420 and the fourth inner portion 422 may be folded towards each other. Specifically, the third inner portion 420 may be folded about a distal end of the third inner portion 420, and the fourth inner portion 422 may be folded about a proximal end of the fourth inner portion 422. In the exemplary aspect depicted in FIG. 4, at the stage 404, the third inner portion 420 and the fourth inner portion 422 may be folded to be perpendicular to the fifth inner portion 424. Stated another way, the third inner portion 420 and the fourth inner portion 422 may be made to be parallel to each other and perpendicular to the fifth inner portion 424 at the stage 404.

At the stage 406, the third inner portion 420 and the fourth inner portion 422 may be folded to overlay on the fifth inner portion 424. Specifically, the third inner portion 420 may be folded about the distal end of the third inner portion 420 to overlay (e.g., completely) on the fifth inner portion 424, and the fourth inner portion 422 may be folded about the proximal end of the fourth inner portion 422 to overlay (e.g., completely) on the fifth inner portion 424 to form the heat exchanger tube 112. In the heat exchanger tube 112 formed by the process described above, the first plurality of ridges 412 and the second plurality of ridges 414 form or act as flow channels of the heat exchanger tube 112 through which the refrigerant flows.

In certain embodiments, folding the third inner portion 420 about the distal end of third inner portion 420 to overlay on the fifth inner portion 424 includes folding the third inner portion 420 and the first outer portion together to overlay on the fifth inner portion 424. Similarly, folding the fourth inner portion 422 about the proximal end of the fourth inner portion 422 to overlay on the fifth inner portion 424 includes folding the fourth inner portion 422 and the third outer portion together to overlay on the fifth inner portion 424.

At the completion of the stage 406, the first plurality of ridges 412 of the third inner portion 420 and the second plurality of ridges 414 of the fourth inner portion 422 may contact the fifth inner portion 424, as shown in FIG. 4. In certain embodiments, the first plurality of ridges 412 and the second plurality of ridges 414 may be attached (e.g., welded) to each other at an intersection point 428, such that a proximal end of the first plurality of ridges 412 and a distal end of the second plurality of ridges 414 may be attached to each other.

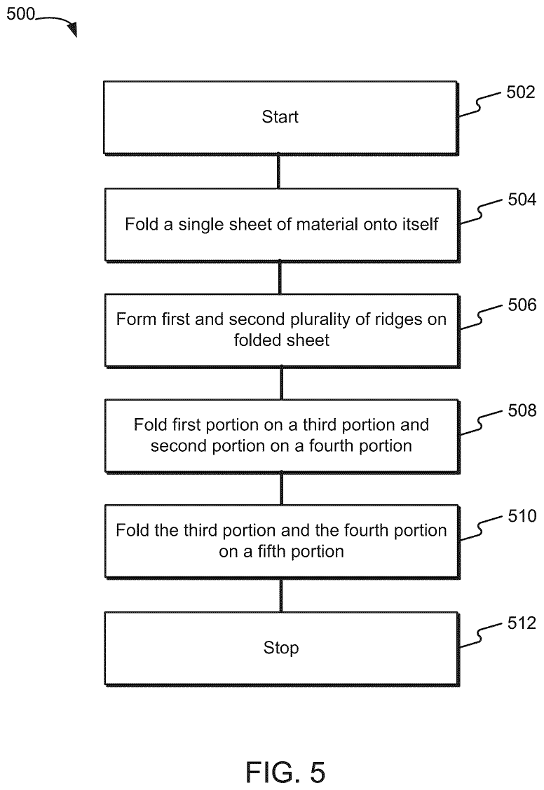

FIG. 5 depicts a flow diagram of an example method 500 to manufacture a heat exchanger tube (e.g., the heat exchanger tube 112) in accordance with one or more embodiments of the present disclosure. FIG. 5 may be described with continued reference to prior figures, including FIGS. 1-4. The following process is exemplary and not confined to the steps described hereafter. Moreover, alternative embodiments may include more or less steps than are shown or described herein and may include these steps in a different order than the order described in the following example embodiments.

The method 500 starts at step 502. At step 504, the method 500 may include folding a single sheet of material onto itself (e.g., into half) to form a folded sheet of material.

At step 506, the method 500 may include forming the first plurality of ridges 314 and the second plurality of ridges 316 on the folded sheet (as described above in conjunction with FIG. 3). Specifically, the first plurality of ridges 314 may be formed on a proximal end of the folded sheet (e.g., on the first portion 318), and the second plurality of ridges 316 may be formed on a distal end of the folded sheet (e.g., on the second portion 320), as described above in conjunction with FIG. 3.

At step 508, the method 500 may include folding the first portion 318 to overlay on the third portion 322, and the second portion 320 to overlay on the fourth portion 324. At step 510, the method 400 may include folding the third portion 322 and the fourth portion 324 to overlay on the fifth portion 326 to form the heat exchanger tube 112 having the first plurality of ridges 314 and the second plurality of ridges 316 as flow channels through which the refrigerant may flow.

The method 500 stops at step 512.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc., should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method of manufacturing a heat exchanger tube, the method comprising:
folding a single sheet of material onto itself to form a folded sheet of material;
forming a first plurality of ridges on a first portion of the folded sheet and a second plurality of ridges on a second portion of the folded sheet, wherein the first portion is disposed at a proximal end of the folded sheet and the second portion is disposed at a distal end of the folded sheet;
folding the first portion about a first portion distal end to overlay on a third portion of the folded sheet;
folding the second portion about a second portion proximal end to overlay on a fourth portion of the folded sheet;
folding the third portion about a third portion distal end to overlay on a fifth portion of the folded sheet; and
folding the fourth portion about a fourth portion proximal end to overlay on the fifth portion to form the heat exchanger tube having the first plurality of ridges and the second plurality of ridges as flow channels.

2. The method of claim 1, wherein the third portion is disposed adjacent to the first portion and the fourth portion is disposed adjacent to the second portion.

3. The method of claim 1, wherein the fifth portion is disposed between the third portion and the fourth portion.

4. The method of claim 1, wherein folding the single sheet of material onto itself comprises folding the single sheet in half.

5. The method of claim 1 further comprising attaching a proximal end of the first plurality of ridges with a distal end of the second plurality of ridges.

6. The method of claim 5, wherein attaching the proximal end of the first plurality of ridges with the distal end of the second plurality of ridges comprises welding the proximal end of the first plurality of ridges with the distal end of the second plurality of ridges.

7. The method of claim 1, wherein forming the first plurality of ridges and the second plurality of ridges comprises forming the first plurality of ridges and the second plurality of ridges in a frustoconical cross-sectional shape.

8. The method of claim 1, wherein the first plurality of ridges and the second plurality of ridges are configured to receive a refrigerant.

9. A heat exchanger tube comprising:
an inner wall; and
an outer wall surrounding the inner wall,
wherein the inner wall and the outer wall comprise a single sheet of material folded onto itself and forming a folded sheet of material, wherein the inner wall and the outer wall comprise a first plurality of ridges on a proximal end of the folded sheet and a second plurality of ridges on a distal end of the folded sheet, and
wherein the inner wall and the outer wall are folded to form a top surface, a bottom surface, and side walls of the heat exchanger tube, and wherein the first plurality of ridges and the second plurality of ridges are folded such that the first plurality of ridges and the second plurality of ridges are disposed between the top surface and the bottom surface and form flow channels in the heat exchanger tube.

10. The heat exchanger tube of claim 9, wherein a proximal end of the first plurality of ridges and a distal end of the second plurality of ridges are attached to each other.

11. The heat exchanger tube of claim 10, wherein the proximal end of the first plurality of ridges and the distal end of the second plurality of ridges are welded to each other.

12. The heat exchanger tube of claim 9, wherein the first plurality of ridges and the second plurality of ridges are configured to receive a refrigerant.

13. The heat exchanger tube of claim 9, wherein the heat exchanger tube is configured to be disposed inside a water tank.

14. The heat exchanger tube of claim 9, wherein the heat exchanger tube is cuboidal shaped, and wherein each of the top surface and the bottom surface is flattened.

15. The heat exchanger tube of claim 9, wherein each of the first plurality of ridges and the second plurality of ridges is a frustoconical cross-section in shape.

16. A water heater comprising:
a water tank configured to store water; and
a heat exchanger configured to receive a refrigerant and transfer heat from the refrigerant to the water stored in the water tank, wherein the heat exchanger comprises a heat exchanger tube, and wherein the heat exchanger tube comprises:
an inner wall; and
an outer wall surrounding the inner wall,
wherein the inner wall and the outer wall comprise a single sheet of material folded onto itself and forming a folded sheet of material, wherein the inner wall and the outer wall comprise a first plurality of ridges on a proximal end of the folded sheet and a second plurality of ridges on a distal end of the folded sheet, and
wherein the inner wall and the outer wall are folded to form a top surface, a bottom surface, and side walls of the heat exchanger tube, and wherein the first plurality of ridges and the second plurality of ridges are folded such that the first plurality of ridges and the second plurality of ridges are disposed between the top surface and the bottom surface and form flow channels in the heat exchanger tube.

17. The water heater of claim 16, wherein a proximal end of the first plurality of ridges and a distal end of the second plurality of ridges are attached to each other.

18. The water heater of claim 16, wherein the first plurality of ridges and the first plurality of ridges are configured to receive the refrigerant.

19. The water heater of claim 16, wherein the heat exchanger tube is cuboidal shaped, and wherein each of the top surface and the bottom surface is flattened.

20. The water heater of claim 16, wherein each of the first plurality of ridges and the second plurality of ridges is a frustoconical cross-section in shape.
